(19) United States
(12) Patent Application Publication
(10) Pub. No.: US 2015/0286752 A1
(43) Pub. Date: Oct. 8, 2015

(54) CONCRETE BLOCK MODULAR INTERFACE

(71) Applicant: Pavestone, LLC, Atlanta, GA (US)

(72) Inventor: William H. Karau, Southlake, TX (US)

(21) Appl. No.: 14/678,409

(22) Filed: Apr. 3, 2015

Related U.S. Application Data
(60) Provisional application No. 61/974,798, filed on Apr. 3, 2014.

(51) Int. Cl. G06F 17/50; G06F 3/0484

(52) U.S. Cl. CPC G06F 17/5004; G06F 3/0484

(57) ABSTRACT

A system for designing a structure comprising a design center system operating on a processor and configured to generate one or more user controls to generate an environment, the design center system further comprising. A model system operating on the processor and configured to receive the environment and to generate one or more user controls to place a plurality of modules at user-selected locations within the environment to form a structure. An assembly sequence system operating on the processor and configured to receive the structure and to generate a plurality of images showing a construction sequence for the structure. A bill of materials system operating on the processor and configured to receive the structure and to generate a bill of materials that lists materials required to build the structure. A countertop design system operating on the processor and configured to receive the structure and to generate a countertop template for the structure. An order generation system operating on the processor and configured to receive the structure and to generate an order for the materials required to build the structure. A remote interface system operating on a second processor and configured to allow a user to access the design center system and to interface with the user controls of the design center system.

### RELATED APPLICATIONS

The present application claims priority to U.S. Provisional Patent Application No. 61/974,798, entitled CONCRETE BLOCK MODULAR INTERFACE, filed Apr. 3, 2014, which is hereby incorporated by reference for all purposes as if set forth herein in its entirety.

### TECHNICAL FIELD

The present disclosure relates to modular masonry block systems, and more specifically to a modular masonry block design system and associated modules that allow a user to easily design and estimate the cost of masonry block structures.

### BACKGROUND OF THE INVENTION

Masonry blocks are used to build various structures, but the design, construction sequence and cost of such structures difficult for a consumer to estimate. Instead, the consumer must hire a masonry contractor for such estimates, and even then, the specific design that the consumer will end up getting might not be certain until the structure is built.

### SUMMARY OF THE INVENTION

A system for designing a structure, comprising a design center system operating on a processor and configured to generate one or more user controls to generate an environment. A model system operating on the processor and configured to receive the environment and to generate one or more user controls to place a plurality of modules at user-selected locations within the environment to form a structure. An assembly sequence system operating on the processor and configured to receive the structure and to generate a plurality of images showing a construction sequence for the structure. A bill of materials system operating on the processor and configured to receive the structure and to generate a bill of materials that lists materials required to build the structure. A countertop design system operating on the processor and configured to receive the structure and to generate a countertop template for the structure. An order generation system operating on the processor and configured to receive the structure and to generate an order for the materials required to build the structure. A remote interface system operating on a second processor and configured to allow a user to access the design center system and to interface with the user controls of the design center system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of wall modules in accordance with an exemplary embodiment of the present disclosure;

FIG. 2 is a diagram of island and table support modules in accordance with an exemplary embodiment of the present disclosure;

FIG. 3 is a diagram of return and termination modules in accordance with an exemplary embodiment of the present disclosure;

FIG. 4 is a diagram of turn modules in accordance with an exemplary embodiment of the present disclosure;

FIG. 5 is a diagram of a grill assembly in accordance with an exemplary embodiment of the present disclosure;

FIG. 6 is a diagram of an outdoor grill assembly in accordance with an exemplary embodiment of the present disclosure; and

FIG. 7 is a diagram of a system for designing and estimating block module projects in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

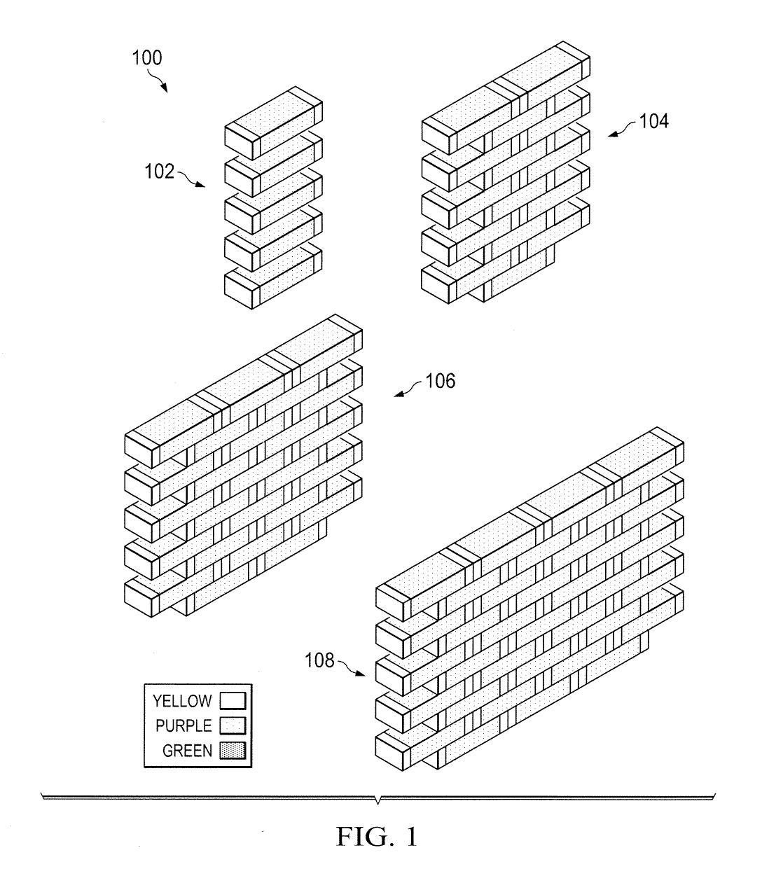

FIG. 1 is a diagram 100 of wall modules 102 through 108 in accordance with an exemplary embodiment of the present disclosure. Wall modules 102 through 108 are 14, 28, 42 and 56 inches in length, respectively, and are made from block modules having three sizes: 1.75″×7″×3.5″ (yellow), 3.50″×7″×7.0″ (green) and 3.50″×7″×10.5″ (purple). Additional block sizes can also or alternatively be used, such as 1.75″×7″×7.0″, 1.75″×7″×10.5″, 3.50″×7″×3.5″, 3.50″×7″×14.0″, 3.50″×7″×2″, 3.50″× odd shapes or other suitable sizes and shapes. The blocks can be formed from masonry, concrete, clay, composites or other suitable materials, and can be coupled to each other with an adhesive, an epoxy, mortar or other suitable bonding materials. The modules can be modelled in software to have graphical, data and functional attributes, so as to allow a user to select the modules and move them around in a design environment, to generate models of structures.

In this exemplary embodiment, module 102 includes five layers of one purple block with two adjacent yellow blocks on either side (Type A). Module 104 includes five upper layers of two adjacent Type A blocks and five lower layers of one Type A block, centered. Module 106 includes five upper layers of three adjacent Type A blocks and five lower layers of two Type A blocks, centered. Module 108 includes five upper layers of four adjacent Type A blocks and five lower layers of three Type A blocks, centered. Although modules 102 through 108 are shown with five or ten exemplary layers of blocks, they can also or alternatively be manufactured with other suitable layers of blocks.

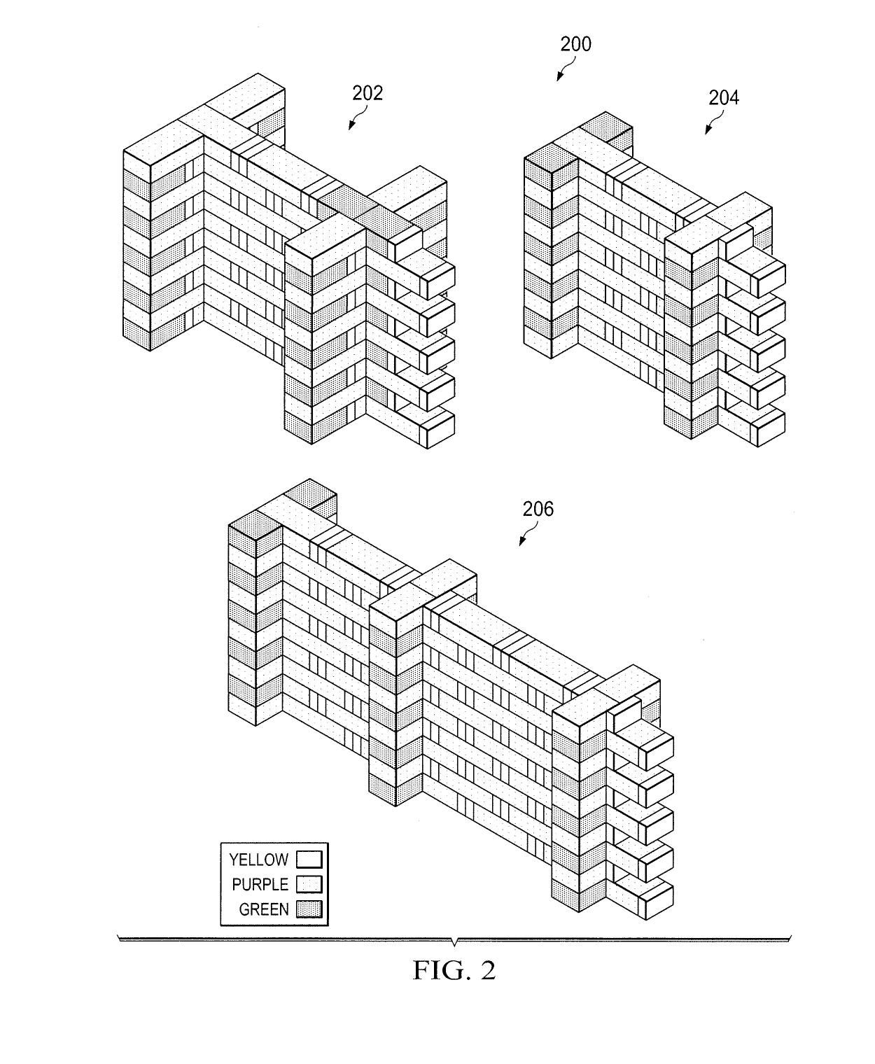

FIG. 2 is a diagram 200 of island and table support modules 202 through 206 in accordance with an exemplary embodiment of the present disclosure. In this exemplary embodiment, module 202 includes an arrangement of blocks in an H shape with an interlocking end section, module 204 includes a shorter arrangement of blocks in a H shape with an interlocking end section, and module 206 includes an arrangement of blocks in two adjacent H shapes with an interlocking end section. Although modules 202 through 206 are shown with ten exemplary layers of yellow/green/purple blocks, they can also or alternatively be manufactured with other suitable layers of other suitable blocks.

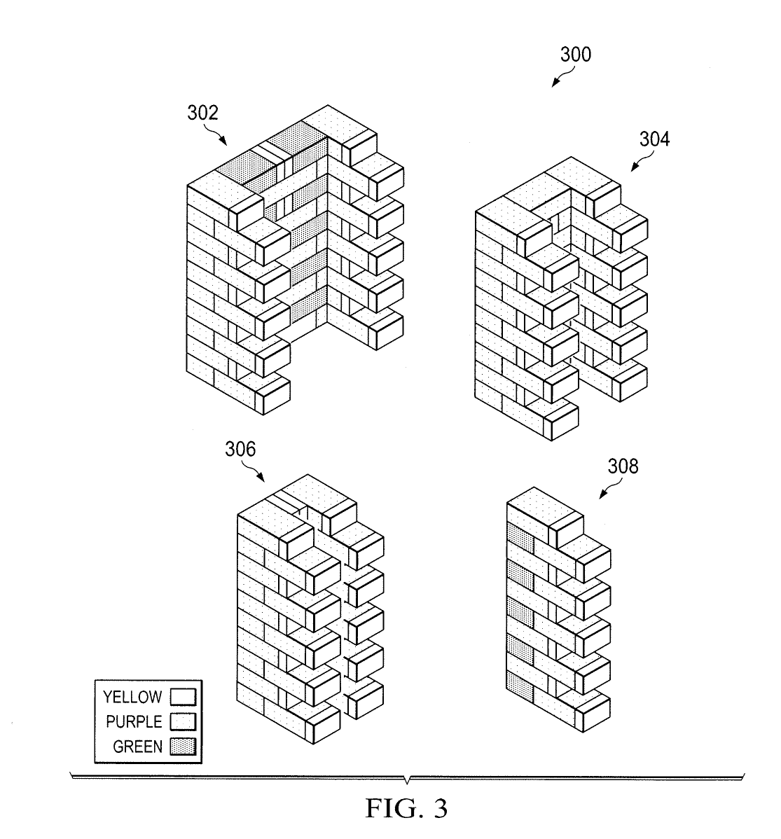

FIG. 3 is a diagram 300 of return and termination modules 302 through 308 in accordance with an exemplary embodiment of the present disclosure. In this exemplary embodiment, module 302 includes an arrangement of blocks in a U shape with two interlocking end sections and a 31.5″ width, module 304 includes a shorter arrangement of blocks in a U shape with an interlocking end section and a 24.5″ width, module 306 includes an arrangement of blocks in a U shape with two interlocking end sections and a 17.5″ width and module 308 includes an arrangement of blocks in an interlocking end section with a 7″ width. Although modules 302 through 308 are shown with ten exemplary layers of yellow/green/purple blocks, they can also or alternatively be manufactured with other suitable 3C layers of other suitable blocks.

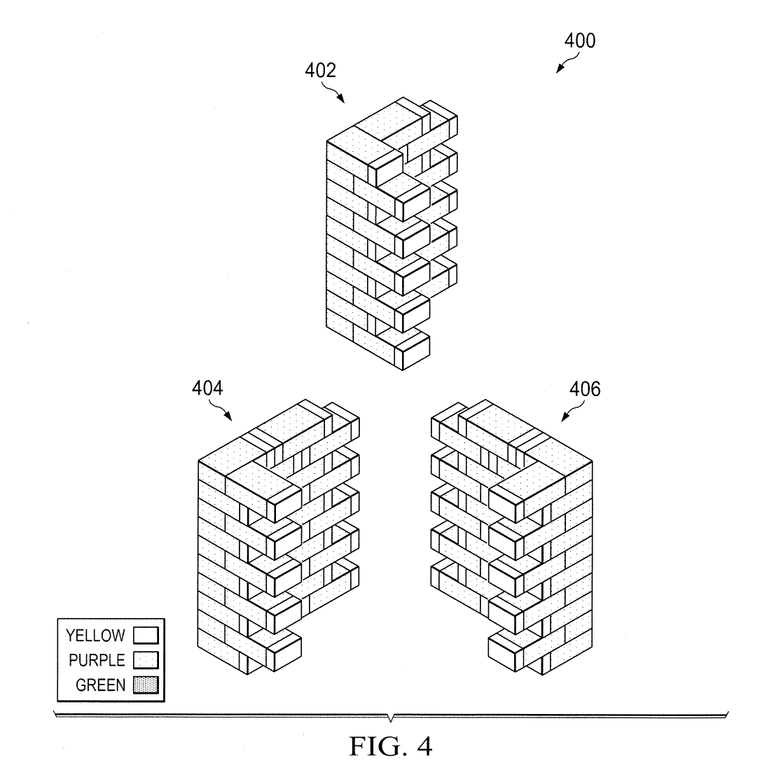

FIG. 4 is a diagram 400 of turn modules 402 through 408 in accordance with an exemplary embodiment of the present disclosure. In this exemplary embodiment, module 402 includes an arrangement of blocks in an L shape with two interlocking end sections, module 404 includes an arrangement of blocks in an L shape with two interlocking end sections, and module 406 includes an arrangement of blocks in an L shape with two interlocking end sections. Although modules 402 through 406 are shown with ten exemplary layers of yellow/green/purple blocks, they can also or alternatively be manufactured with other suitable layers of other suitable blocks.

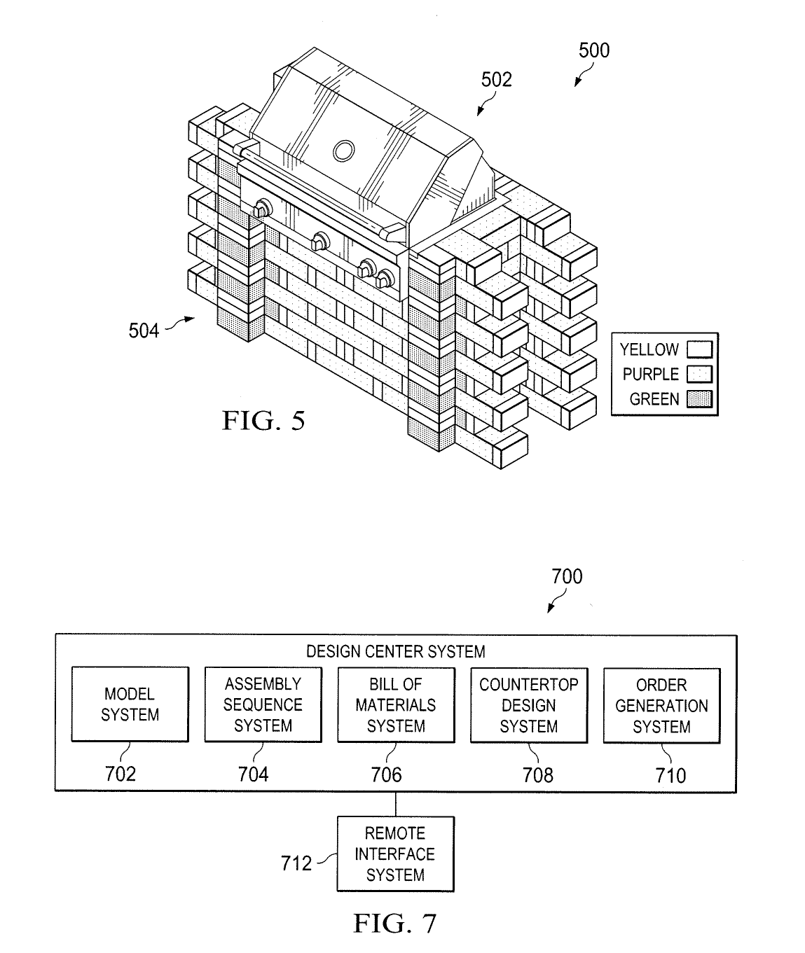

FIG. 5 is a diagram 500 of a grill assembly in accordance with an exemplary embodiment of the present disclosure. The grill assembly includes built-in grill 502 and base 504, which is constructed from the arrangement of yellow, green and purple blocks as shown. The specific arrangement of yellow, green and purple blocks is selected based on the dimensions of built-in grill 502, which can come in a variety of different sizes.

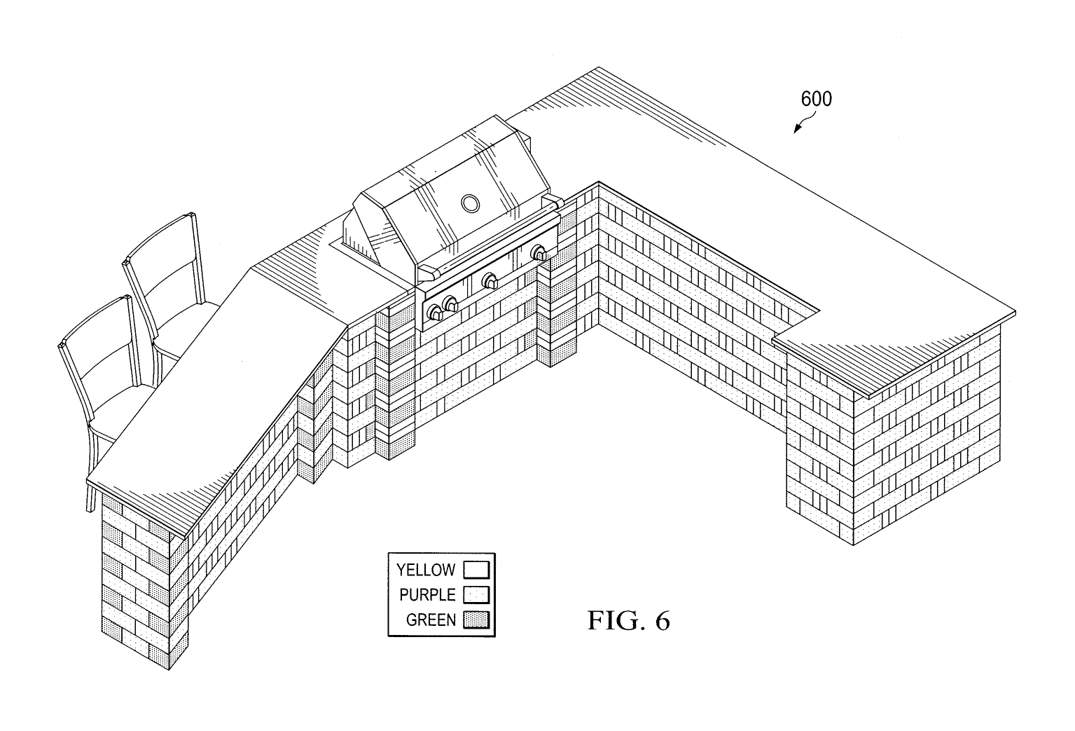

FIG. 6 is a diagram 600 of an outdoor grill assembly in accordance with an exemplary embodiment of the present disclosure. The outdoor grill assembly includes a granite countertop on top of wall modules, island and table support modules, return and termination modules and turn modules, arranged as shown, with a built-in grill.

FIG. 7 is a diagram of a design center system 700 for designing and estimating block module projects in accordance with an exemplary embodiment of the present disclosure. Design center system 700 includes model system 702, assembly sequence system 704, bill of materials system 706, countertop design system 708, order generation system 710 and remote interface system 712, each of which can be implemented in hardware or a suitable combination of hardware or software, and which can be one or more software systems operating on a processor.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Design center system 700 generates a user interface that allows a user to set up an account, select individual block modules from a plurality of modules, move the block modules around in an environment and to perform other suitable functions. In one exemplary embodiment, a user can upload a picture or design file of an area (such as the user's backyard), can select design environments from a set of pre-existing and modifiable design environments, or can otherwise generate a design environment, and can then populate the design environment with block modules that are arranged and placed as selected by the user.

Model system 702 generates one or more user controls that allow a user to select one or more block modules and to arrange the block modules in a user-selected arrangement. In one exemplary embodiment, a block module can include one or more “hooks” that cause it to connect to an adjacent block module, such as after selection of a user control, as well as other user controls that allow the block module to be selected, moved, modified, swapped out, inverted, rotated or otherwise manipulated. In this manner, the user can configure the block modules as desired to fit a space within the design environment.

Assembly sequence system 704 receives a selected set of modules that have been arranged by a user and generates an assembly sequence that can be used to build the arranged modules. In one exemplary embodiment, assembly sequence system 704 can include a plurality of algorithms that generate images showing successive layers of blocks for the assembled modules, can include positions at which to apply an adhesive or mortar, can generate instructions for preparing a construction area or masonry blocks for assembly, or other suitable algorithms, and can generate the sequence of images after activation of a user-selectable control.

Bill of materials system 706 receives a selected set of modules that have been arranged by a user and generates a bill of materials that includes the materials that will be required to construct the selected set of modules. In one exemplary embodiment, bill of materials system 706 can include one or more algorithms that generate a list of materials associated with each selected module, additional materials associated with connecting modules, additional materials associated with preparing a location for installation of an assembly or other suitable materials, and can include shipping, pricing and other suitable data. In this manner, a lay user can design a structure and can then receive a bill of materials that identifies all of the materials that a user will need to build the structure. Bill of materials system 706 can also or alternatively allow a user to add additional materials to the bill of materials, delete materials from the bill of materials, can automatically generate suggestions for reducing the price (such as by reconfiguring the structure designed by the user) or can perform other suitable functions.

Countertop design system 708 generates a countertop template for a structure design by a user. In one exemplary embodiment, countertop design system 708 can include one or more algorithms that generate a countertop segment for an associated module and that join the countertop segments into a single countertop template, such as to allow the user to provide the countertop template to a countertop fabricator. Countertop design system 708 can also or alternatively provide cost estimate data, can provide an interface for use by countertop fabricators (such as to allow them to receive the template over an electronic data connection), or can perform other suitable functions.

Order generation system 710 receives bill of material data, purchaser data, delivery address data, payment data and other suitable data and generates an order. In one exemplary embodiment, order generation system 710 can generate a user control that allows the user to place the order from a design screen, a bill of materials screen or other suitable screens, such as to allow the user to make a “one click” purchase. In another exemplary embodiment, the user can arrange financing, set up a layaway plan or make other suitable purchase arrangements.

Remote interface system 712 allows the user to access design center system 700 over a network or other suitable communications medium. In one exemplary embodiment, remote interface system 712 can be a thin client application, a web browser interface, a pad computer application, a smart phone application, a smart television application or other suitable applications or systems that interface with a remote server, a cloud computing environment or other suitable systems that are used to operate design center system 700.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A mating interface of a building element, comprising:
a lower vertical plane having height X and width 2X;
a lower contiguous horizontal plane having width 2X and length Y;
a contiguous vertical plane having height X and width 2X, superposed above the lower vertical plane; and
a contiguous horizontal plane having width 2X and length Y, superposed above the lower horizontal plane.

2. The building element of claim 1 wherein Y=X.

3. The building element of claim 1, wherein Y=2X.

4. A building element with a mating interface, comprising:
a first block with a vertical plane having height X and width 2X;
a contiguous horizontal plane of the first block having width 2X and length Y;
a second block with a vertical plane having height X and width 2X, the second block superposed above the vertical plane of the first block; and
a contiguous horizontal plane of the second block having width 2X and length Y, superposed above the horizontal plane of the first block.

5. The building element of claim 4 wherein Y=X.

6. The building element of claim 4, wherein Y=2X.

7. The building element of claim 4 further comprising a third block disposed between the first block and the second block.

8. The building element of claim 4 further comprising a third block disposed between the first block and the second block, the third block comprising:
a vertical plane having height X and width 2X disposed offset from the vertical plane of the first block and the vertical plane of the second block; and
a contiguous horizontal plane having width 2X and length Y.

9. The building element of claim 8 further comprising fourth block disposed above the second block, the fourth block comprising:
a vertical plane having height X and width 2X superposed above the vertical plane of the third block; and
a contiguous horizontal plane having width 2X and length Y.

10. The building element of claim 4 further comprising a design center system operating on a processor and configured to generate one or more user controls to generate an environment.

11. The building element of claim 10 further comprising a model system operating on the processor and configured to receive the environment and to generate one or more user controls to place a plurality of modules at user-selected locations within the environment to form a structure.

12. The building element of claim 11 further comprising an assembly sequence system operating on the processor and configured to receive the structure and to generate a plurality of images showing a construction sequence for the structure.

13. The building element of claim 12 further comprising a bill of materials system operating on the processor and configured to receive the structure and to generate a bill of materials that lists materials required to build the structure.

14. The building element of claim 13 further comprising a countertop design system operating on the processor and configured to receive the structure and to generate a countertop template for the structure.

15. The building element of claim 14 further comprising an order generation system operating on the processor and configured to receive the structure and to generate an order for the materials required to build the structure.

16. The building element of claim 15 further comprising a remote interface system operating on a second processor and configured to allow a user to access the design center system and to interface with the user controls of the design center system.

17. A system for designing a structure comprising:
a design center system operating on a processor and configured to generate one or more user controls to generate an environment, the design center system further comprising:
a model system operating on the processor and configured to receive the environment and to generate one or more user controls to place a plurality of modules at user-selected locations within the environment to form a structure;
an assembly sequence system operating on the processor and configured to receive the structure and to generate a plurality of images showing a construction sequence for the structure;
a bill of materials system operating on the processor and configured to receive the structure and to generate a bill of materials that lists materials required to build the structure;
a countertop design system operating on the processor and configured to receive the structure and to generate a countertop template for the structure;
an order generation system operating on the processor and configured to receive the structure and to generate an order for the materials required to build the structure; and
a remote interface system operating on a second processor and configured to allow a user to access the design center system and to interface with the user controls of the design center system;
a first block with a vertical plane having height X and width 2X;
a contiguous horizontal plane of the first block having width 2X and length Y;
a second block with a vertical plane having height X and width 2X, the second block superposed above the vertical plane of the first block; and
a contiguous horizontal plane of the second block having width 2X and length Y, superposed above the horizontal plane of the first block;
a third block disposed between the first block and the second block, the third block comprising:
a vertical plane having height X and width 2X disposed offset from the vertical plane of the first block and the vertical plane of the second block; and
a contiguous horizontal plane having width 2X and length Y;
a fourth block disposed above the second block, the fourth block comprising:
a vertical plane having height X and width 2X superposed above the vertical plane of the third block; and
a contiguous horizontal plane having width 2X and length Y; and
wherein Y=X or Y=2X.
